(19) United States
(12) Patent Application Publication
(10) Pub. No.: US 2026/0361781 A1
(43) Pub. Date: Nov. 12, 2026

(54) HIERARCHICAL RTP HEADER EXTENSION FOR PROCESSING INFORMATION

(71) Applicant: QUALCOMM Incorporated, San Diego, CA (US)

(72) Inventors: Liangping Ma, San Diego, CA (US); Nikolai Konrad Leung, San Francisco, CA (US)

(21) Appl. No.: 19/670,885

(22) Filed: May 7, 2026

Related U.S. Application Data
(60) Provisional application No. 63/803,390, filed on May 9, 2025.
(60) Provisional application No. 63/849,588, filed on Jul. 23, 2025.
(60) Provisional application No. 63/914,948, filed on Nov. 10, 2025.

(51) Int. Cl. H04L 65/70; H04L 65/65

(52) U.S. Cl. CPC H04L 65/70; H04L 65/65

(57) ABSTRACT

This disclosure describes techniques for processing audio data. A sending device determines processing information of a processing information type. The processing information contains metadata used for rendering the audio data. The sending device generates a packet header extension containing a summary field and the processing information. The summary field indicates a presence or an absence of the processing information type within the processing information. The sending device generates a transport packet containing the packet header extension. The sending device outputs the transport packet to a receiving device.

This application claims the benefit of U.S. Provisional Patent Application No. 63/803,390, filed May 9, 2025, U.S. Provisional Patent Application No. 63/849,588, filed Jul. 23, 2025, and U.S. Provisional Patent Application No. 63/914,948, filed Nov. 10, 2025, the entire content of which is incorporated by reference herein.

### TECHNICAL FIELD

This disclosure relates to transport of data, such as audio data, metadata, and/or processing information (PI).

### BACKGROUND

Digital video and audio capabilities can be incorporated into a wide range of devices, including digital televisions, digital direct broadcast systems, wireless broadcast systems, personal digital assistants, laptop or desktop computers, tablet computers, e-book readers, digital cameras, digital recording devices, digital media players, video gaming devices, video game consoles, cellular or satellite radio telephones, smart phones, video teleconferencing devices, and video streaming devices. Digital media devices implement audio and video compression techniques, such as techniques described in the standards defined by the Moving Picture Experts Group, International Telecommunication Union Telecommunication Standardization Sector, and other standards-developing organizations. Media devices transmit, receive, encode, decode, and store digital information efficiently by implementing audio and video compression techniques.

Media streaming and communication sessions utilize transport protocols to deliver data over networks. The Real-Time Transport Protocol (RTP) provides a framework for the delivery of audio and video data in real-time applications. Transport packets include a header section for routing and control information and a payload section containing the media content. Specific protocols support header extensions, and the header extensions allow for the inclusion of additional information beyond the standard header fields to facilitate specialized processing or rendering of the media data at a receiving device.

In the context of immersive audio services, such as Immersive Voice and Audio Services (IVAS), a bitstream can include different types of information for a media receiver. The different types of information can include coded audio signals and metadata used for rendering the audio signals. Metadata provides spatial or environmental parameters, such as orientation or position details, and the spatial or environmental parameters assist a renderer in producing a high-fidelity audio experience. Proper organization and signaling of the additional information within the transport layer support the accurate and synchronized delivery of media content across various network architectures.

### SUMMARY

This disclosure describes techniques for improving the transport and processing of media data through a hierarchical architecture for processing information (PI) within a transport packet. A sending device determines PI associated with an audio signal and generates a corresponding packet header extension. The packet header extension includes a summary field and the PI. The summary field includes information indicative of a presence or an absence of specific PI types within the packet header extension. By utilizing a summary field, a receiving device can quickly identify and parse relevant PI frames without requiring separate signaling syntaxes for every individual information type.

In some implementations, the summary field comprises a bit map where specific bit positions correspond to pre-assigned indices for various PI types, such as scene orientation, device orientation, or acoustic environment parameters. The packet header extension can further include a dedicated header section with one or more PI headers. The PI headers explicitly define a type and a size of each corresponding PI data frame. Explicitly defining the size resolves ambiguities when multiple variable-size frames are packed together, ensuring a decoder can accurately parse and reassemble the PI data for rendering.

To accommodate large PI payloads, the techniques support the use of multiple header extension elements within a single transport packet. A device can distribute data across multiple header extension elements sharing a same header extension identifier.

Distributing data across multiple header extension elements effectively bypasses maximum size constraints of traditional header formats. These structured approaches provide a compact and extensible framework, simplifying negotiation and improving the scalability of media delivery systems for immersive audio applications.

In one example, this disclosure is directed to an apparatus for processing audio data, the apparatus comprising one or more memories, and one or more processors in communication with the one or more memories, the one or more processors configured to determine processing information of at least one processing information type, the processing information comprising metadata used for rendering the audio data, generate a packet header extension comprising a summary field and the processing information, the summary field comprising information indicative of a presence or an absence of the at least one processing information type within the processing information, generate a packet comprising the packet header extension, and output the packet.

In another example, this disclosure is directed to an apparatus for processing audio data, the apparatus comprising one or more memories, and one or more processors in communication with the one or more memories, the one or more processors configured to receive a packet comprising a packet header extension, the packet header extension comprising a summary field and processing information of at least one processing information type, the processing information comprising metadata used for rendering the audio data, the summary field comprising information indicative of a presence or an absence of the at least one processing information type within the processing information, and render the audio data using the processing information.

In another example, this disclosure is directed to a method for processing audio data, the method comprising determining processing information of at least one processing information type, the processing information comprising metadata used for rendering the audio data, generating a packet header extension comprising a summary field and the processing information, the summary field comprising information indicative of a presence or an absence of the at least one processing information type within the processing information, generating a packet comprising the packet header extension, and outputting the packet.

The details of one or more examples are set forth in the accompanying drawings and the description below. Other features, objects, and advantages will be apparent from the description and drawings, and from the claims.

### BRIEF DESCRIPTION OF DRAWINGS

FIG. 1A is a block diagram illustrating an example system that implements techniques for streaming media data over a network.

FIG. 1B is a block diagram illustrating another example system that implements techniques for streaming media data over a network.

FIG. 2 is a conceptual diagram illustrating an example packet format at various levels of detail.

FIG. 3 is a tabular diagram illustrating an example table of 20 existing PI types set forth in S4-250652.

FIG. 4 is a conceptual diagram illustrating an example RTP header extension according to one or more aspects of this disclosure.

FIG. 5 is a conceptual diagram illustrating another example RTP header extension according to one or more aspects of this disclosure.

FIGS. 6A-6C are tabular diagrams illustrating an example table of PI types set forth in TS26.253 and indicating which PI types are variable-size PI types.

FIG. 7 is a conceptual diagram illustrating an example RTP packet with an RTP header extension element for PI according to one or more aspects of this disclosure.

FIG. 8 is a conceptual diagram illustrating an example format for a PI header according to one or more aspects of this disclosure.

FIG. 9 is a conceptual diagram illustrating another example RTP packet with an RTP header extension element for PI according to one or more aspects of this disclosure.

FIG. 10 is a flow diagram illustrating an example use of a hierarchical RTP header extension for processing information according to one or more aspects of this disclosure.

FIG. 11 is a flow diagram illustrating another example use of a hierarchical RTP header extension for processing information according to one or more aspects of this disclosure.

### DETAILED DESCRIPTION

Existing approaches for transporting media data often include Processing Information (PI) data within a Real-Time Transport Protocol (RTP) payload. Moving PI data from the RTP payload to the RTP header extension presents several technical challenges due to a large number of PI types and variable sizes of PI frames. Specifically, the large number of potential PI types makes a standard 1-byte RTP header extension format insufficient, as the 1-byte RTP header extension format only supports up to fourteen extension types. Furthermore, defining distinct Session Description Protocol (SDP) syntaxes for every PI type creates overly complex signaling requirements and necessitates frequent updates to Internet Assigned Numbers Authority (IANA) registrations. Known techniques also struggle with size ambiguities when a device packs multiple variable-size PI frames into a single header element. Moreover, a total size of the PI data may exceed capacity limits of a single 1-byte or 2-byte RTP header extension element.

To address these technical challenges, the techniques of this disclosure introduce a hierarchical architecture for carrying PI data within an RTP header extension. In some examples, an apparatus determines a PI frame associated with an audio signal and generates a corresponding PI header that explicitly indicates a type and a size for the PI frame. The apparatus generates a transport packet by inserting a header extension element including the PI header and the PI frame. This structured approach includes a summary field, such as a bit map, to indicate a presence or an absence of various PI types, thereby allowing a single Uniform Resource Name (URN) and a single header extension type to represent all possible PI.

The disclosed techniques provide several technical advantages over existing approaches. By consolidating all PI types into a single hierarchical header extension, the system significantly simplifies SDP negotiation and eliminates a need for constant IANA updates. The use of explicit PI headers defining both type and size resolves ambiguity associated with variable-length payloads, ensuring a receiving decoder can accurately parse and reassemble the PI data for rendering. Furthermore, the disclosure establishes a mechanism to carry large PI payloads by distributing data across multiple RTP header extension elements with a same identifier in a single packet, effectively bypassing maximum size constraints of traditional header formats. These improvements enhance scalability and efficiency of media delivery systems for immersive audio applications in resource-constrained environments. Furthermore, by adopting internal payload data structures that closely mirror the existing payload formats defined in current telecommunication specifications (such as the PI header section and PI frame data section utilized in existing 3GPP standards), the disclosed techniques minimize structural deviations. This deliberate alignment preserves familiar parsing logic, thereby reducing the implementation burden on network endpoints and facilitating smoother industry-wide standardization and adoption of the proposed RTP header extension formats.

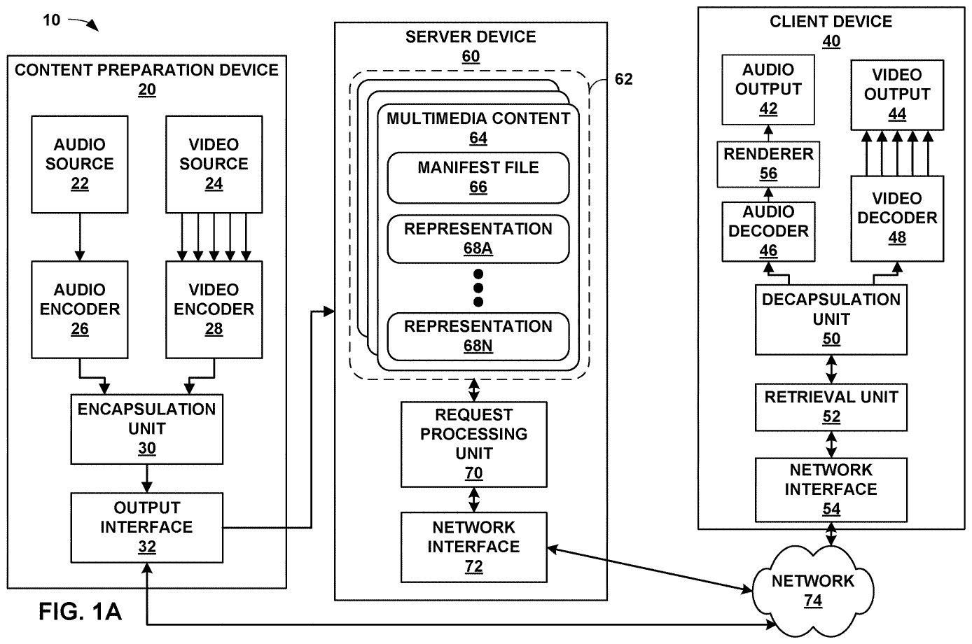

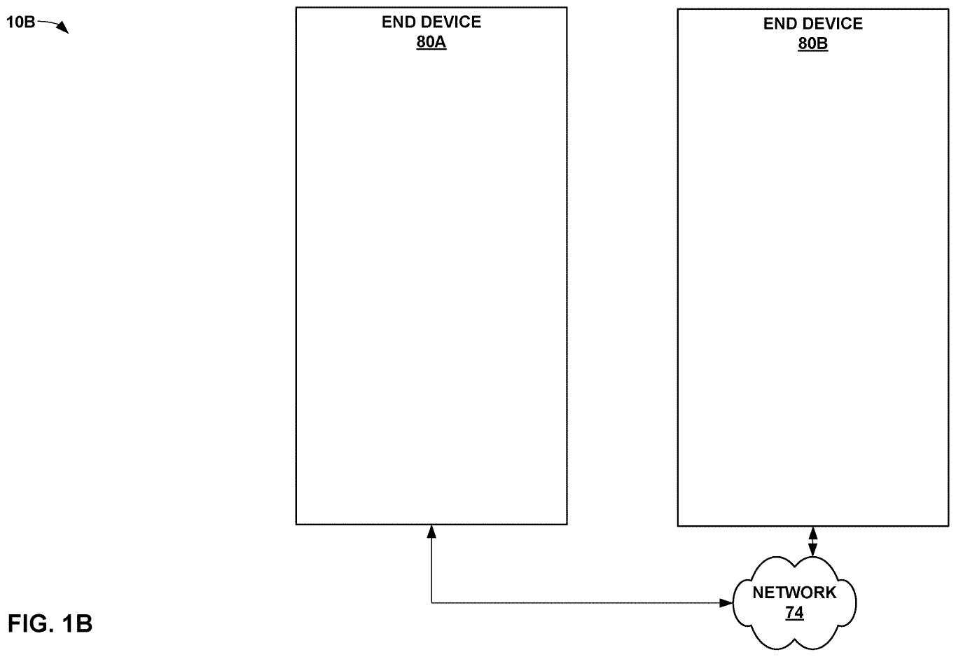

FIG. 1A is a block diagram illustrating an example system 10 that implements techniques for streaming media data over a network. In this example, system 10 includes content preparation device 20, server device 60, and client device 40. Server device 60 may be an Extended Reality (XR) application server. Client device 40 and server device 60 are communicatively coupled by network 74, which may comprise a wireless wide area network, a wireless local area network, the Internet, and/or the like. In some examples, content preparation device 20 and server device 60 may also be coupled by network 74 or another network, or may be directly communicatively coupled. In some examples, content preparation device 20 and server device 60 may comprise the same device. It should be noted that an IVAS codec may not process video data and, as such, in IVAS only implementations, video components of FIG. 1A may be deleted. Other codecs may process video data and include the video components of FIG. 1A.

Content preparation device 20, in the example of FIG. 1A, may include audio source 22 and video source 24. Audio source 22 may comprise, for example, a microphone that produces electrical signals representative of captured audio data to be encoded by audio encoder 26. In some examples, audio encoder 26 represents an IVAS encoder. Alternatively, audio source 22 may comprise storage media storing previously recorded audio data, an audio data generator such as a computerized synthesizer, or any other source of audio data. Video source 24 may comprise a video camera that produces video data to be encoded by video encoder 28, storage media encoded with previously recorded video data, a video data generation unit such as a computer graphics source, or any other source of video data. Content preparation device 20 is not necessarily communicatively coupled to server device 60 in all examples, but may store multimedia content to separate media that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise computer-readable storage media comprising stored audio data, and video source 24 may comprise computer-readable storage media comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for an encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data, but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a representation. For example, the coded video or audio part of the representation can be an elementary stream. An elementary stream may be converted into a packetized elementary stream (PES) before being encapsulated within a video file. Within the same representation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

Many video coding standards, such as ITU-T H.264/AVC and the High Efficiency Video Coding (HEVC) standard, define the syntax, semantics, and decoding process for error-free bitstreams, any of which conform to a certain profile or level. Video coding standards typically do not specify the encoder, but the encoder is tasked with guaranteeing that the generated bitstreams are standard-compliant for a decoder. In the context of video coding standards, a “profile” corresponds to a subset of algorithms, features, or tools and constraints that apply to them. As defined by the H.264 standard, for example, a “profile” is a subset of the entire bitstream syntax that is specified by the H.264 standard. A “level” corresponds to the limitations of the decoder resource consumption, such as, for example, decoder memory and computation, which are related to the resolution of the pictures, bit rate, and block processing rate. A profile may be signaled with a profile_idc (profile indicator) value, while a level may be signaled with a level_idc (level indicator) value.

The H.264 standard, for example, recognizes that, within the bounds imposed by the syntax of a given profile, it is still possible to require a large variation in the performance of encoders and decoders depending upon the values taken by syntax elements in the bitstream such as the specified size of the decoded pictures. The H.264 standard further recognizes that, in many applications, it is neither practical nor economical to implement a decoder capable of dealing with all hypothetical uses of the syntax within a particular profile. Accordingly, the H.264 standard defines a “level” as a specified set of constraints imposed on values of the syntax elements in the bitstream. These constraints may be simple limits on values. Alternatively, these constraints may take the form of constraints on arithmetic combinations of values (e.g., picture width multiplied by picture height multiplied by number of pictures decoded per second). The H.264 standard further provides that individual implementations may support a different level for each supported profile.

A decoder conforming to a profile ordinarily supports all the features defined in the profile. For example, as a coding feature, B-picture coding is not supported in the baseline profile of H.264/AVC but is supported in other profiles of H.264/AVC. A decoder conforming to a level should be capable of decoding any bitstream that does not require resources beyond the limitations defined in the level. Definitions of profiles and levels may be helpful for interpretability. For example, during video transmission, a pair of profile and level definitions may be negotiated and agreed for a whole transmission session. More specifically, in H.264/AVC, a level may define limitations on the number of macroblocks that need to be processed, decoded picture buffer (DPB) size, coded picture buffer (CPB) size, vertical motion vector range, maximum number of motion vectors per two consecutive macroblocks (MBs), and whether a B-block can have sub-macroblock partitions less than 8×8 pixels. In this manner, a decoder may determine whether the decoder is capable of properly decoding the bitstream.

In the example of FIG. 1A, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream id that identifies the elementary stream to which the PES packet belongs. Encapsulation unit 30 is responsible for assembling elementary streams into video files (e.g., segments) of various representations.

Encapsulation unit 30 receives PES packets for elementary streams of a representation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not be repeated for each sequence or picture; hence, coding efficiency may be improved. Furthermore, the use of parameter sets may enable out-of-band transmission of the applicable header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not utilized for decoding the coded picture samples from VCL NAL units, but may assist in processes related to decoding, display, error resilience, and other purposes. SEI messages may be contained in non-VCL NAL units. SEI messages are the normative part of some standard specifications, and thus are not generally mandatory for standard compliant decoder implementation. SEI messages may be sequence level SEI messages or picture level SEI messages. Some sequence level information may be contained in SEI messages, such as scalability information SEI messages in the example of Scalable Video Coding (SVC) and view scalability information SEI messages in Multiview Video Coding (MVC). These example SEI messages may convey information on, e.g., extraction of operation points and characteristics of the operation points. In addition, encapsulation unit 30 may form a manifest file, such as a media presentation descriptor (MPD) that describes characteristics of the representations. Encapsulation unit 30 may format the MPD according to extensible markup language (XML).

Encapsulation unit 30 may provide data for one or more representations of multimedia content, along with the manifest file (e.g., the MPD) to output interface 32. Output interface 32 may comprise a network interface or an interface for writing to storage media, such as a universal serial bus (USB) interface, a CD or DVD writer or burner, an interface to magnetic or flash storage media, or other interfaces for storing or transmitting media data. Encapsulation unit 30 may provide data of each of the representations of multimedia content to output interface 32, which may send the data to server device 60 via network transmission or storage media. In the example of FIG. 1A, server device 60 includes storage media 62 that stores various multimedia content 64, each including a respective manifest file 66 and one or more representations 68A-68N (representations 68). In some examples, output interface 32 may also send data directly to network 74.

In some examples, representations 68 may be separated into adaptation sets. That is, various subsets of representations 68 may include respective common sets of characteristics, such as codec, profile and level, resolution, number of views, file format for segments, text type information that may identify a language or other characteristics of text to be displayed with the representation and/or audio data to be decoded and presented, e.g., by speakers, camera angle information that may describe a camera angle or real-world camera perspective of a scene for representations in the adaptation set, rating information that describes content suitability for particular audiences, or the like.

Manifest file 66 may include data indicative of the subsets of representations 68 corresponding to particular adaptation sets, as well as common characteristics for the adaptation sets. Manifest file 66 may also include data representative of individual characteristics, such as bitrates, for individual representations of adaptation sets. In this manner, an adaptation set may provide for simplified network bandwidth adaptation. Representations in an adaptation set may be indicated using child elements of an adaptation set element of manifest file 66.

Server device 60 includes request processing unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64, and include components that conform substantially to those of server device 60. In general, network interface 72 is configured to send and receive data via network 74.

Request processing unit 70 is configured to receive network requests from client devices, such as client device 40, for data of storage media 62. In some examples, request processing unit 70 may receive network requests from client device 40 in the form of RTP/SRTP packets and may deliver content, such as XR application content, to client device 40 in the form of RTP/SRTP packets.

Additionally, or alternatively, request processing unit 70 may implement hypertext transfer protocol (HTTP) version 1.1, as described in Request for Comments (RFC) 2616, “Hypertext Transfer Protocol—HTTP/1.1,” by R. Fielding et al, Network Working Group, Internet Engineering Task Force (IETF), June 1999. That is, request processing unit 70 may be configured to receive HTTP GET or partial GET requests and provide data of multimedia content 64 in response to the requests. The requests may specify a segment of one of representations 68, e.g., using a Uniform Resource Locator (URL) of the segment. In some examples, the requests may also specify one or more byte ranges of the segment, thus comprising partial GET requests. Request processing unit 70 may further be configured to service HTTP HEAD requests to provide header data of a segment of one of representations 68. In any case, request processing unit 70 may be configured to process the requests to provide requested data to a requesting device, such as client device 40.

Additionally, or alternatively, request processing unit 70 may be configured to deliver media data via a broadcast or multicast protocol, such as eMBMS. Content preparation device 20 may create Dynamic Adaptive Streaming over HTTP (DASH) segments and/or sub-segments in substantially the same way as described, but server device 60 may deliver these segments or sub-segments using eMBMS or another broadcast or multicast network transport protocol. For example, request processing unit 70 may be configured to receive a multicast group join request from client device 40. That is, server device 60 may advertise an Internet protocol (IP) address associated with a multicast group to client devices, including client device 40, associated with particular media content (e.g., a broadcast of a live event). Client device 40, in turn, may submit a request to join the multicast group. This request may be propagated throughout network 74, e.g., routers making up network 74, such that the routers are caused to direct traffic destined for the IP address associated with the multicast group to subscribing client devices, such as client device 40.

As illustrated in the example of FIG. 1A, multimedia content 64 includes manifest file 66, which may correspond to a media presentation description (MPD). Manifest file 66 may contain descriptions of different alternative representations 68 (e.g., video services with different qualities) and the description may include, e.g., codec information, a profile value, a level value, a bit rate, and other descriptive characteristics of representations 68. Client device 40 may retrieve the MPD of a media presentation to determine how to access segments of representations 68.

In particular, retrieval unit 52 may retrieve configuration data (not shown) of client device 40 to determine decoding capabilities of video decoder 48 and rendering capabilities of video output 44. The configuration data may also include any or all of a language preference selected by a user of client device 40, one or more camera perspectives corresponding to depth preferences set by the user of client device 40, and/or a rating preference selected by the user of client device 40. Retrieval unit 52 may comprise, for example, a web browser or a media client configured to submit HTTP GET and partial GET requests. Retrieval unit 52 may correspond to software instructions executed by one or more processors or processing units (not shown) of client device 40. In some examples, all or portions of the functionality described with respect to retrieval unit 52 may be implemented in hardware, or a combination of hardware, software, and/or firmware, where requisite hardware may be provided to execute instructions for software or firmware.

Retrieval unit 52 may compare the decoding and rendering capabilities of client device 40 to characteristics of representations 68 indicated by information of manifest file 66. Retrieval unit 52 may initially retrieve at least a portion of manifest file 66 to determine characteristics of representations 68. For example, retrieval unit 52 may request a portion of manifest file 66 that describes characteristics of one or more adaptation sets. Retrieval unit 52 may select a subset of representations 68 (e.g., an adaptation set) having characteristics that can be satisfied by the coding and rendering capabilities of client device 40. Retrieval unit 52 may then determine bitrates for representations in the adaptation set, determine a currently available amount of network bandwidth, and retrieve segments from one of the representations having a bitrate that can be satisfied by the network bandwidth.

In general, higher bitrate representations may yield higher quality video playback, while lower bitrate representations may provide sufficient quality video playback when available network bandwidth decreases. Accordingly, when available network bandwidth is relatively high, retrieval unit 52 may retrieve data from relatively high bitrate representations, whereas when available network bandwidth is low, retrieval unit 52 may retrieve data from relatively low bitrate representations. In this manner, client device 40 may stream multimedia data over network 74 while also adapting to changing network bandwidth availability of network 74.

Additionally, or alternatively, retrieval unit 52 may be configured to receive data in accordance with a broadcast or multicast network protocol, such as eMBMS or IP multicast. In such examples, retrieval unit 52 may submit a request to join a multicast network group associated with particular media content. After joining the multicast group, retrieval unit 52 may receive data of the multicast group without further requests issued to server device 60 or content preparation device 20. Retrieval unit 52 may submit a request to leave the multicast group when data of the multicast group is no longer needed, e.g., to stop playback or to change channels to a different multicast group.

Network interface 54 may receive and provide data of segments of a selected representation to retrieval unit 52, which may in turn provide the segments to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to renderer 56 for rendering audio output 42, while video decoder 48 decodes encoded video data and sends the decoded video data, which may include a plurality of views of a stream, to video output 44. In some examples, audio decoder 46 represents an IVAS decoder or an Enhanced Voice Services (EVS) decoder. In some examples, audio decoder 46 represents a decoder that is not an IVAS decoder or an EVS decoder. For example, audio decoder 46 may decode frames of audio data. These frames of audio data may include metadata, such as azimuth, elevation, radius, pitch, and yaw information. Renderer 56 may receive PI data frames which may include PI data such as scene orientation data, device orientation (compensated) data, device orientation (uncompensated) data, acoustic environment data, or the like, which renderer 56 may use when rendering audio output 42.

Video encoder 28, video decoder 48, audio encoder 26, audio decoder 46, renderer 56, encapsulation unit 30, retrieval unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, renderer 56, encapsulation unit 30, retrieval unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well as audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

A media presentation may include a media presentation description (MPD), which may contain descriptions of different alternative representations (e.g., video services with different qualities) and the description may include, e.g., codec information, a profile value, and a level value. An MPD is one example of a manifest file, such as manifest file 66. Client device 40 may retrieve the MPD of a media presentation to determine how to access movie fragments of various presentations. Movie fragments may be located in movie fragment boxes (moof boxes) of video files.

Manifest file 66 (which may comprise, for example, an MPD) may advertise availability of segments of representations 68. That is, the MPD may include information indicating the wall-clock time at which a first segment of one of representations 68 becomes available, as well as information indicating the durations of segments within representations 68. In this manner, retrieval unit 52 of client device 40 may determine when each segment is available, based on the starting time as well as the durations of the segments preceding a particular segment.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to computer-readable storage media such as, for example, an optical drive, a magnetic media drive (e.g., floppy drive), a universal serial bus (USB) port, a network interface, and/or other output interface. Output interface 32 outputs the video file to computer-readable media, such as, for example, a transmission signal, a magnetic medium, an optical medium, a memory, a flash drive, and/or other computer-readable media.

Network interface 54 may receive a NAL unit or access unit via network 74 and provide the NAL unit or access unit to decapsulation unit 50, via retrieval unit 52. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

The example of FIG. 1A describes the use of RTP, DASH, and HTTP-based streaming for purposes of example. However, it should be understood that other types of protocols may be used to transport media data. For example, request processing unit 70 and retrieval unit 52 may be configured to operate according to Real-Time Streaming Protocol (RTSP), or the like, and use supporting protocols such as Session Description Protocol (SDP) or Session Initiation Protocol (SIP).

FIG. 1B is a block diagram illustrating another example system that implements techniques for streaming media data over a network. FIG. 1B is similar to the example of FIG. 1A, but FIG. 1B includes two end devices, rather than a client device and a server device. For example, each end device 80A and 80B of system 10B may be configured to both consume content from and provide content to the other of end device 80A and 80B. The system of FIG. 1B may implement the techniques disclosed herein.

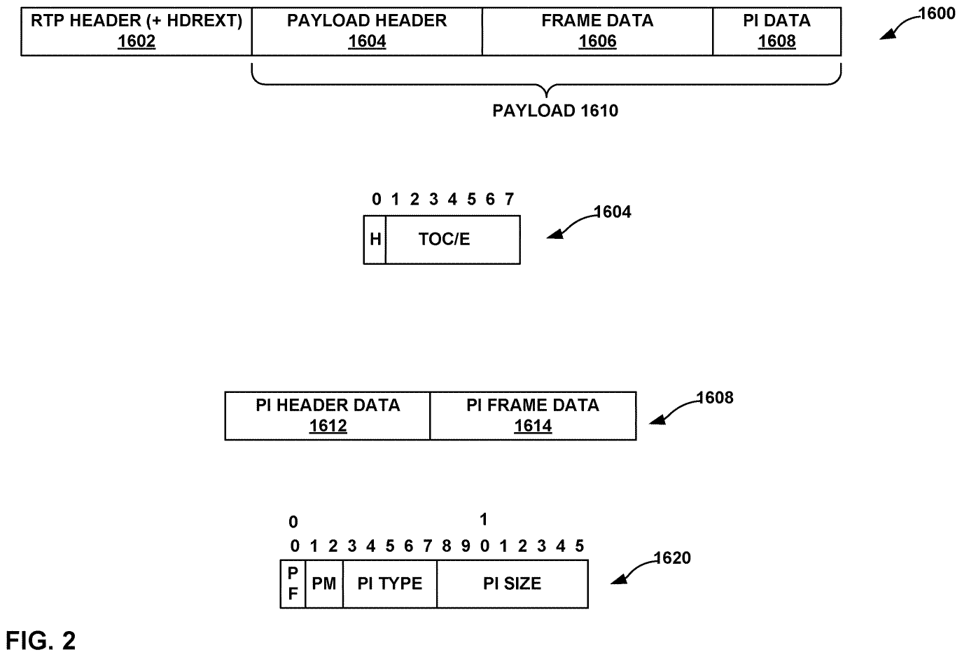

FIG. 2 is a conceptual diagram illustrating an example packet format at various levels of detail. For example, packet 1600 may be an RTP packet whose format is defined in TS26.253. Packet 1600 may include RTP header 1602 which may, in some examples, include a header extension (HDREXT), payload header 1604, frame data 1606, and PI data 1608. Payload header 1604, frame data 1606, and PI data 1608 may together make up payload 1610 of packet 1600. In some examples, payload 1610 may be an IVAS payload. In some examples, rather than making up an IVAS payload, payload header 1604, frame data 1606, and PI data 1608 may together make up a different type of payload, such as that of an EVS frame, another codec frame, or a NO_DATA frame.

Payload header 1604 may include a table of contents (ToC) byte and/or extra (E) byte. The ToC byte may define or identify the content in frame data 1606. In some examples, there is a ToC byte for each IVAS, EVS frame, another codec frame, and/or NO_DATA frame. The E byte may contain extra information and may precede the ToC byte of the coded frame.

Frame data 1606 may include audio data and metadata. For example, frame data 1606 may include one or more frames and those frames may include audio data and/or metadata intended to be available to audio decoder 46 (e.g., not PI data).

PI data 1608 may include PI data, including a PI header data 1612 and PI frame data 1614. PI header data 1612 may include one or more PI data headers, such as PI data header 1620, each of the PI data headers identifying the type and size for a corresponding PI data frame in PI frame data 1614, and identifying with which audio frame(s) the corresponding PI data frame is associated. PI frame data 1614 may include one or more PI data frames, each of the PI data frames being of a specific PI data type. For example, a sending computing device, such as server device 60 may generate packet 1600 and include different types of PI data into different PI data frames. The PI data frames may include PI data intended to be available to renderer 56.

For example, PI data header 1620 may include a PF field which may be a bit that is indicative of whether another PI data header follows this particular PI data header in the packet. PI data header 1620 may include a PM field which may be two bits indicative of which audio frame is associated with the PI data frame for which PI data header 1620 corresponds. PI data header 1620 may include a PI type field which may be five bits indicative of the type of PI data included in a corresponding PI data frame. PI data header 1620 may include a PI size field that indicates a size of the corresponding PI data frame in bytes. For example, a PI data packet may include one or more PI data headers like PI data header 1620, and one or more PI data frames, each being of a PI data type.

Instead of sending PI data in an RTP packet payload, it may be simpler and more flexible to send PI data in an RTP header extension. Such a scheme was proposed in S4-250652 (3GPP TSG-SA4 Meeting #131-bis-e, Online, 11th April 2025-17th April 2025).

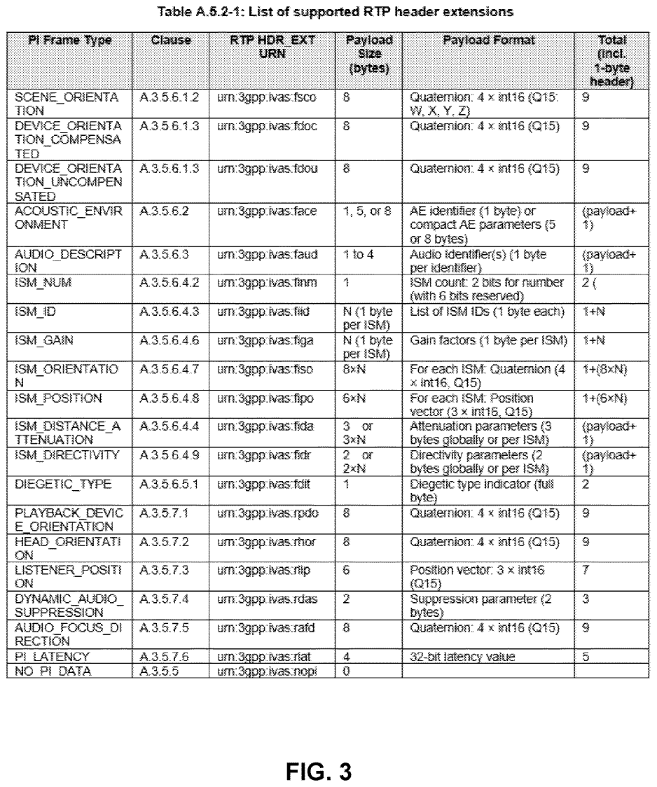

FIG. 3 is a tabular diagram illustrating an example table of 20 existing PI types set forth in S4-250652. As can be seen, there are currently 20 different PI types (shown as “PI Frame Type”).

The current 1-byte RTP header extension format supports up to 14 different header extension types. As such, it is impossible for an RTP sender to use the current RTP header extension format to represent all 20 of the current PI types shown in FIG. 3. Moreover, SDP signaling may become quite complicated because 20 different SDP syntaxes need to be defined. Additionally, if more PI types are defined, additional SDP syntaxes would need to be defined and the IANA registration would need to be updated. As such, it may be desirable to use a different RTP header extension format to communicate PI data.

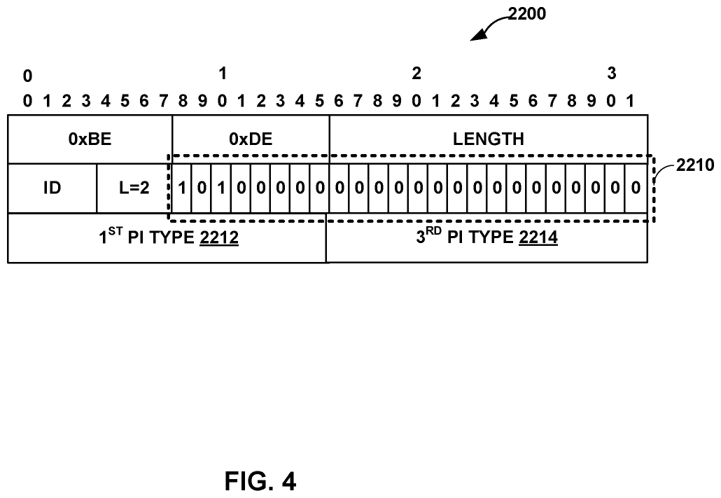

FIG. 4 is a conceptual diagram illustrating an example RTP header extension according to one or more aspects of this disclosure. RTP header extension 2200 may be a single RTP header extension type that is defined for all possible PI. A data portion of RTP header extension 2200 may follow a hierarchical architecture. For example, the data portion may include a summary field 2210 to indicate the presence or absence of any PI types included within RTP header extension 2200. In some examples, summary field 2210 may include a 3-byte bit map where a 1 at bit k represents the presence of the kth PI type and 0 represents the absence. For example, summary field 2210 includes a 1 in the first bit of the 3-byte bit map, indicating the presence of PI of the 1^{st} type within RTP header extension 2200. Summary field 2210 also includes a 1 in the third bit of the 3-byte bit map, indicating the presence of PI of the 3^{rd} type within RTP header extension 2200. Each other bit in summary field 2210 is a 0, indicating that PI of the other 18 PI types are not included in RTP header extension 2200. The data portion of RTP header extension 2200 may also include actual PI data: 1^{st} PI type data 2212; and 3^{rd} PI type data 2214.

RTP header extension 2200 may be a relatively compact and extensible RTP header extension for use with PI. In some examples, each PI type may be pre-assigned an index that may represent one of the bits in a bit map of summary field 2210. Such pre-assignment may be made in an industry standard. In some examples, the PI of the PI types that are present in RTP header extension 2200 may follow summary field 2210. In some examples, a single Uniform Resource Name (URN) is registered with IANA to cover RTP header extension 2200. As such, the SDP negotiation between the RTP sender and RTP receiver may negotiate the URN, rather than any specific PI type.

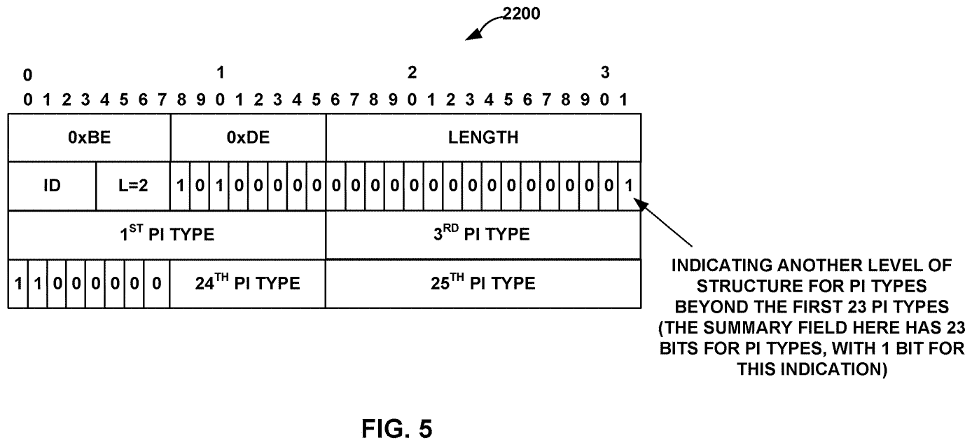

The summary field in the RTP header extension for PI may include an indication that indicates the existence of an additional structure that includes a second summary field and a second plurality of PI types as indicated by the second summary field. This structure allows for more flexibility in adopting more PI types that cannot be accommodated by the first summary field due to the limited length of the first summary field. A bit in the first summary field may be used for the indication. The bit may be the last bit of the first summary field. For example, when the bit is 1, it indicates the existence of a second summary field and the possibility of a second plurality of PI types, and when the bit is 0, it indicates the absence of a second summary field and absence of a second plurality of PI types. In some aspects, the length of the second summary field is fixed, e.g., at 8 bits. An example is shown in FIG. 5. This hierarchical structure can repeat, being able to accommodate any number of PI types. This recursive structure may ensure support for future PI types.

However, in some examples, a PI type may have a variable size. For example, the size of the Independent Stream with Metadata (ISM) frame types depends on the number of ISM's. In another example, the size of an ACOUSTIC_ENVIRONMENT PI frame may be 1, 5, or 8 bytes. In another example, the size of an AUDIO_DESCRIPTION PI frame may be 1 or 4 bytes.

As such, techniques described above may not always resolve the ambiguity of the sizes of the PI frames if multiple variable-size PI frames are included in a single RTP header extension element. Additionally, the RTP header extensions (1-byte or 2-byte) can support limited sizes: 16 bytes and 255 bytes, respectively.

Thus, devices, systems, methods, and computer readable media that address these additional issues may be desirable.

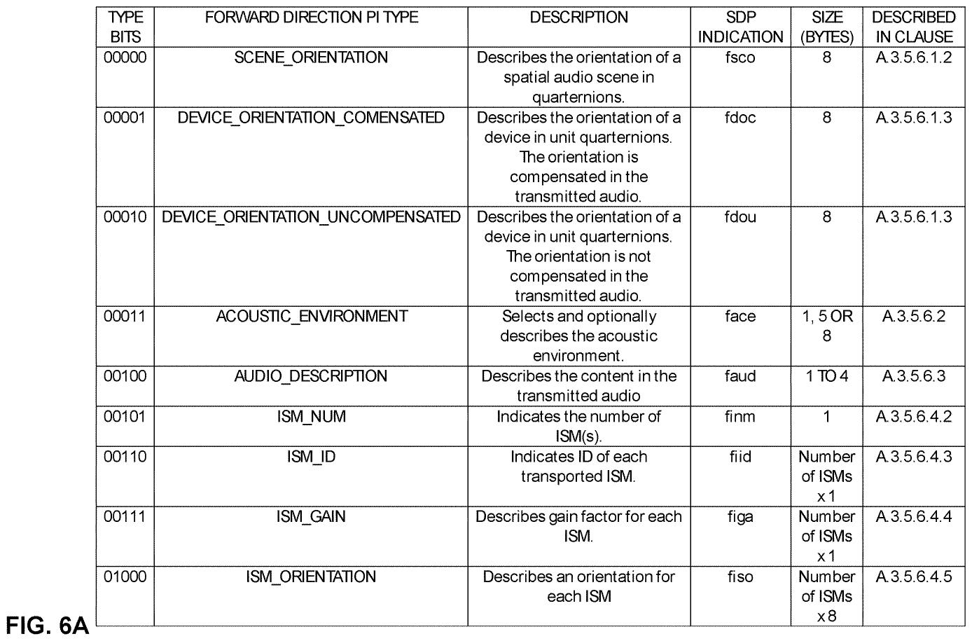

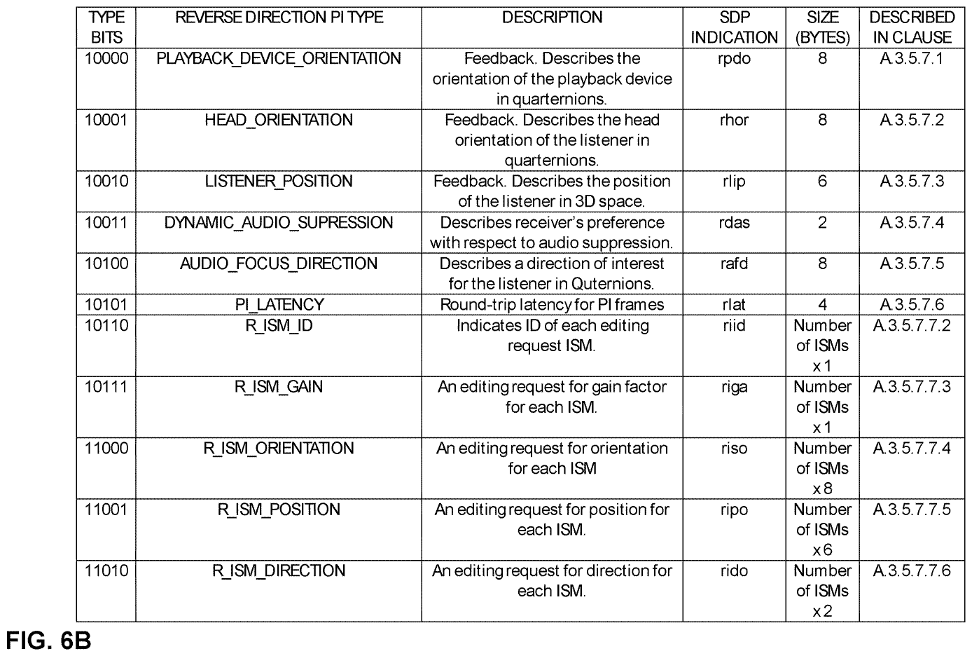

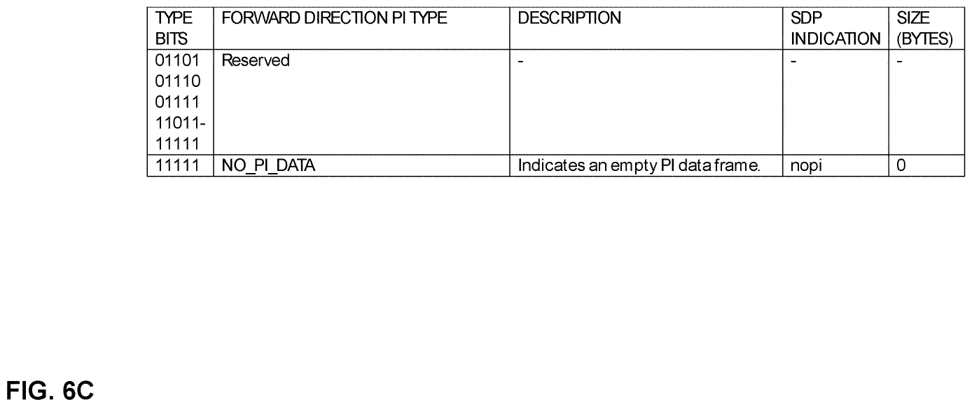

FIGS. 6A-6C are tabular diagrams illustrating an example table of PI types set forth in TS26.253 and indicating which PI types are variable-size PI types. FIG. 6A represents Table A.3.5.5-1: Supported forward direction PI types in an IVAS session. FIG. 6B represents Table A.3.5.5-1A: Supported reverse direction PI types in an IVAS session. FIG. 6C represents Table A.3.5.5-2: Additional PI types in an IVAS session. Amongst those PI types set forth in FIGS. 6A-6C, the following PI types (listed by the Type bits) are variable-size PI types: 00011, 00100, 00110, 00111, 01000, 01001, 01010, 01011, 10110, 10111, 11000, 11001, and 11010.

Example 1: The sizes of variable-size PI frames that are present in an RTP header extension element for PI are included in the RTP header extension element, which already includes the following (as described above): A summary field to indicate the presence or absence of PI types, e.g., a 3-byte bit map where 1 at bit k represents the presence of the kth PI type and 0 represents the absence. Such PI types may have pre-assigned indices which may be set forth, for example, in a standards specification. The PI types that are present may follow the summary field.

Referring back to FIG. 4, summary field 2210 may indicate the presence or absence of any PI types included within RTP header extension 2200. In some examples, summary field 2210 may include a 3-byte bit map where a 1 at bit k represents the presence of the kth PI type and 0 represents the absence. For example, summary field 2210 includes a 1 in the first bit of the 3-byte bit map, indicating the presence of PI of the 1st type within RTP header extension 2200. Summary field 2210 also includes a 1 in the third bit of the 3-byte bit map, indicating the presence of PI of the 3rd type within RTP header extension 2200. Each other bit in summary field 2210 is a 0, indicating that PI of the other 18 PI types are not included in RTP header extension 2200.

Referring back to FIG. 5, the summary field in the RTP header extension for PI may include an indication (e.g., a bit) that indicates the existence of an additional structure that includes a second summary field and a second plurality of PI types as indicated by the second summary field. The 3-byte summary field may allocate 23 bits to represent the first 23 PI types, reserving the 24th bit as the indicator flag for the second summary field. The bit may be the last bit of the first summary field. For example, when the bit is 1, it indicates the existence of another level of structure beyond the first 23 PI types, e.g., the second summary field and the possibility of a second plurality of PI types (e.g., a 24th PI type and a 25th PI type), and when the bit is 0, it indicates the absence of a second summary field and absence of a second plurality of PI types.

Example 2: Use multiple instances of PI RTP header extensions with different composing PI frames. The end-points (e.g., server device 60 and client device 40, or end device 80A and end device 80B) may negotiate multiple PI RTP header extension types. Each PI RTP header extension type may follow an architecture described herein. Each RTP header extension type may be defined for all possible PI, where the data portion of the RTP header extension element follows a hierarchical architecture. For example, the hierarchical architecture may include a summary field to indicate the presence or absence of PI types, e.g., a 3-byte bit map where 1 at bit k represents the presence of the kth PI type and 0 represents the absence. The PI types may have pre-assigned indices set forth, for example, in a standards specification. The PI types that are present may follow the summary field. In some examples, a single URN is registered with IANA to cover the RTP header extension (e.g., RTP header extension 2200). As such, the SDP negotiation between the RTP sender and RTP receiver may negotiate the URN, rather than any specific PI type.

Referring back to FIG. 2, in one example, the payload of an RTP header extension element includes a PI frame data section (e.g., 1608) including PI frames and a PI header section which includes one or more PI headers. Each PI header may have the format shown in PI data header 1620. In some examples, the PF field may be 1 bit: If this bit is set to 1, the bit indicates that the PI header indication is followed by another PI header indication. If this bit is set to 0, the bit indicates that this PI header indication is the last PI header indication in this payload and no further PI header indication follows this entry.

In some examples, the PM field may be 2 bits: PI frame marker (PM) bits may indicate the associated audio frame for the PI data frame according to the table below:

| PM bits | Frame marker indication |
|---|---|
| 00 | Reserved |
| 01 | Not last PI header for this frame |
| 10 | Last PI header for this frame |
| 11 | General (applied to all frames) |

As used herein, the frame marker indication for the general state applied to all frames designates that the corresponding processing information applies to all audio frames contained within the current RTP packet 1600. Alternatively, in some implementations, the general state may indicate that the processing information applies to all audio frames in a specific ongoing sequence or adaptation set managed by the server device 60.

In some examples, the PI type field may be 5 bits: PI type bits indicate the type for the PI data.

In some examples, the PI size field may be 8 bits: PI size bits indicate the size for the PI data frame in bytes.

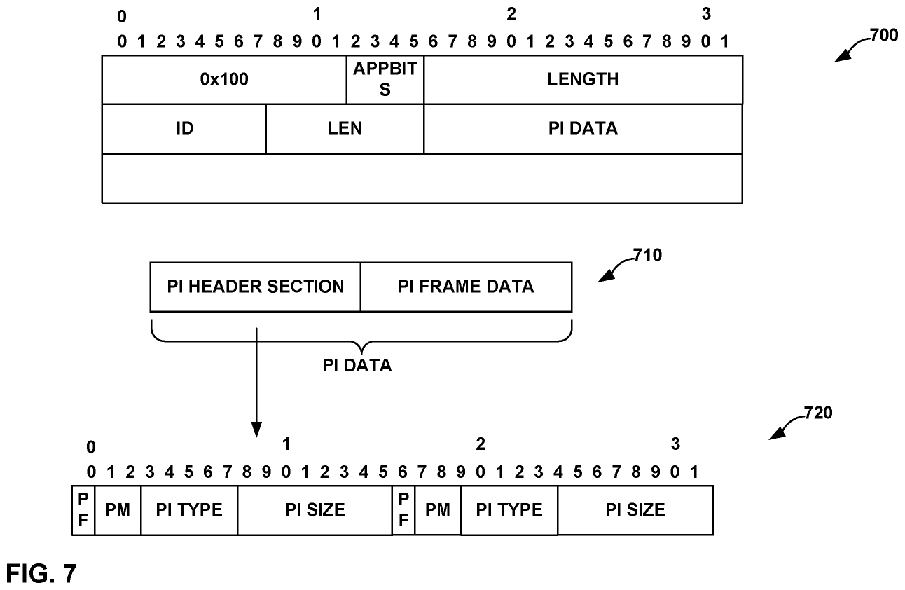

FIG. 7 is a conceptual diagram illustrating an example RTP packet with an RTP header extension element for PI according to one or more aspects of this disclosure. RTP packet 700 is shown with a breakout of PI data 710 and a further detailed view of PI data 720. The RTP packet 700 further includes an appbits field within the header extension element. The 0x100 field may represent a 12-bit identifier which is complemented by the appbits field. The appbits field may be a 4-bit field that, together with the 12-bit 0x100 identifier, forms a complete 16-bit profile identifier. The appbits field includes application-specific bits that may be utilized by an application layer of the server device 60 or the client device 40 for custom signaling, payload alignment, or indicating application-specific routing requirements over the network 74.

In another example, the payload of an RTP header extension element for PI includes a series of PI units. Each PI unit includes a PI header and a PI frame. The selection between utilizing a distinct PI header section and a series of interleaved PI units may depend on specific network conditions or the parsing capabilities of the client device 40. Grouping all PI headers together allows the decapsulation unit 50 to perform efficient bulk parsing of metadata configurations before processing any variable-length payload data. Conversely, utilizing a sequential series of PI units 910 allows the audio decoder 46 and the renderer 56 to process individual PI frames in a continuous stream, which can reduce memory buffering requirements on resource-constrained devices.

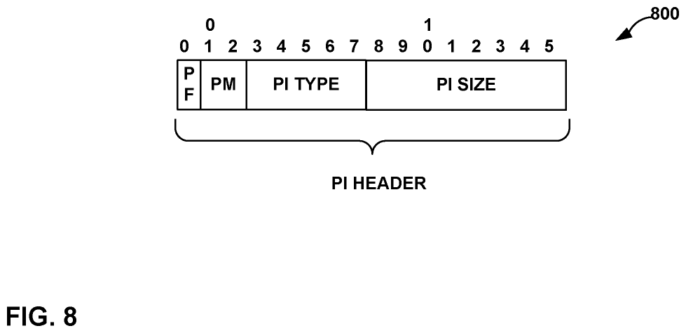

FIG. 8 is a conceptual diagram illustrating an example format for a PI header according to one or more aspects of this disclosure. In some examples, each PI header may have the format of PI header 800 of FIG. 8.

In some examples, the R field may be 1 bit: a reserved bit. In some examples, the reserved bit R is set to a default value of zero by the server device 60 during encoding and is ignored by the client device 40 upon receipt. Because the R field is reserved and does not explicitly flag the continuation of PI units, the decapsulation unit 50 of the client device 40 may determine the end of the series of PI units 910 by evaluating the overall length field provided in the standard RTP header 1602. By tracking the accumulated size of each parsed PI frame against the total specified length of the header extension, the client device 40 definitively identifies the final PI unit 920 in the payload without requiring a dedicated continuation bit.

In some examples, the PM field may be 2 bits: PI frame marker (PM) bits may indicate the associated audio frame for the PI data frame according to the table below:

| PM bits | Frame marker indication |
|---|---|
| 00 | Reserved |
| 01 | Not last PI header for this frame |
| 10 | Last PI header for this frame |
| 11 | General (applied to all frames) |

In some examples, the PI type field may be 5 bits: PI type bits indicate the type for the PI data.

In some examples, the PI size field may be 8 bits: PI size bits indicate the size for the PI data frame in bytes. In instances where a single processing information frame exceeds the 255-byte limit imposed by the 8-bit PI size field, the server device 60 may fragment the oversized processing information data across multiple PI units 910. The server device 60 can utilize the PM bits within successive PI headers to indicate that multiple segmented PI frames correspond to the same audio frame, allowing the renderer 56 to reassemble the complete processing information dataset prior to rendering the audio output 42.

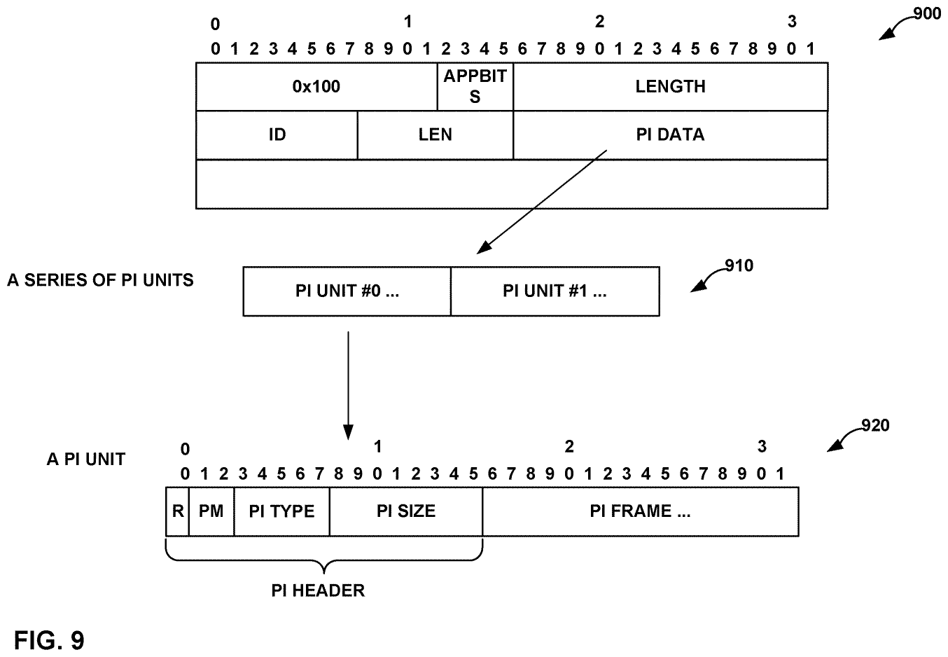

FIG. 9 is a conceptual diagram illustrating another example RTP packet with an RTP header extension element for PI according to one or more aspects of this disclosure. RTP packet 900 is shown with a breakout of a series of PI units 910 and a breakout of a single PI unit 920.

In some examples, the techniques of this disclosure may include the use of multiple RTP header extension elements for PI in a single RTP packet. For example, client device 40, server device 60, end device 80A, or end device 80B may use multiple RTP header extension elements for the PI in a single RTP packet. The potential size of the PI may be larger than the size of a single RTP header extension element (e.g., the 1-byte format supports up to 14 bytes and the 2-byte format supports 256 bytes). In some examples, a single RTP packet may carry multiple RTP header extension elements for PI, where the RTP header extensions follow a format described herein, have the same header extension ID, but may have different lengths, and may carry different types of PI frames and the associated PI headers. Upon receiving a single RTP packet containing multiple RTP header extension elements for PI, the decapsulation unit 50 of the client device 40 extracts and concatenates the processing information from each sequential extension element. The client device 40 relies on the sequential ordering of the header extensions and the explicit PM bits within each PI data header 1620 to maintain the correct temporal alignment, ensuring the renderer 56 accurately reassembles the fragmented data before applying the spatial metadata to the audio output 42.

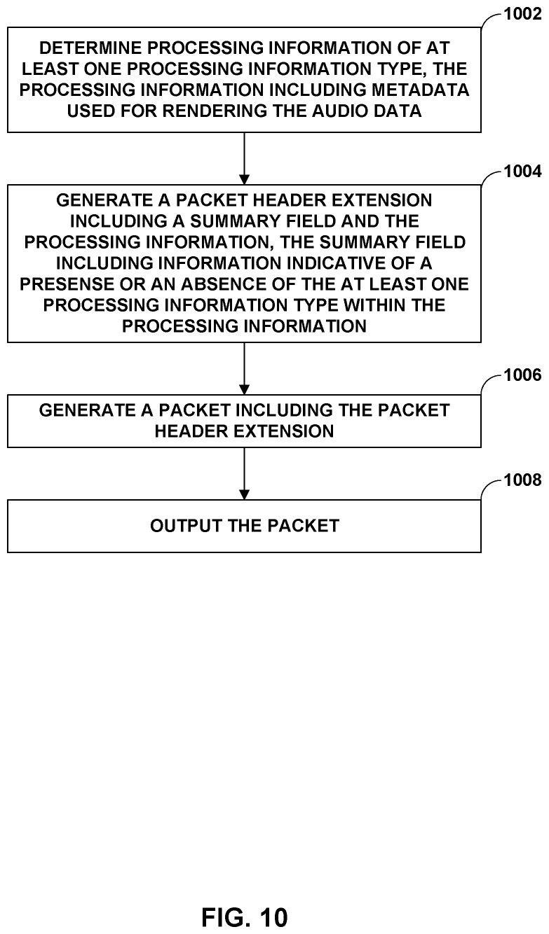

FIG. 10 is a flow diagram illustrating an example use of a hierarchical RTP header extension for processing information according to one or more aspects of this disclosure. While described with respect to content preparation device 20 or server device 60, the techniques of FIG. 10 may be practiced by any device capable of doing so.

Content preparation device 20 or server device 60 may determine processing information of at least one processing information type, the processing information including metadata used for rendering audio data (1002). For example, content preparation device 20 or server device 60 may determine that particular processing information may be useful to client device 40 to render associated audio data and may determine or generate such processing information.

Content preparation device 20 or server device 60 may generate a packet header extension comprising a summary field and the processing information, the summary field including information indicative of a presence or an absence of the at least one processing information type within the processing information (1004). For example, content preparation device 20 or server device 60 may generate a packet header extension, such as an RTP packet header extension. Content preparation device 20 or server device 60 may generate the packet header extension to include a summary field and the processing information. The processing information may be included within one or more frames within the packet header extension.

In some examples, the information indicative of the presence or the absence of the at least one processing information type may include a bit map. In some examples, the bit map may include a three-byte bit map, wherein a value of one located at a kth bit of the three-byte bit map indicates a presence of a kth processing information type. In some examples, the summary field may include an indicator bit, the indicator bit indicating an existence of an additional structure within the packet header extension, wherein the additional structure comprises a second summary field. In some examples, the packet header extension may include a processing information header section and a processing information frame data section, wherein the processing information header section includes at least one processing information header. In some examples, the at least one processing information header may include a size field indicating a size of a corresponding processing information frame within the processing information frame data section. In some examples, the at least one processing information header may include a flag bit indicating whether a subsequent processing information header follows the at least one processing information header. In some examples, the packet header extension may include a series of processing information units, wherein each processing information unit of the series of processing information units includes a processing information header and a processing information frame.

Content preparation device 20 or server device 60 may generate a packet comprising the packet header extension (1006). The packet may include an RTP packet. To generate the packet, content preparation device 20 or server device 60 may include a plurality of packet header extensions in the packet, the plurality of packet header extensions including the packet header extension. In some examples, each packet header extension of the plurality of packet header extensions may include a same header extension identifier and may not be of uniform length. In some examples, each of the plurality of packet header extensions may include a same header extension identifier and at least one of the plurality of packet header extensions may carry a different processing information frame and an associated processing information header than a remainder of the plurality of packet header extensions.

Content preparation device 20 or server device 60 may output the packet (1008). For example, content preparation device 20 or server device 60 may transmit the packet to client device 40.

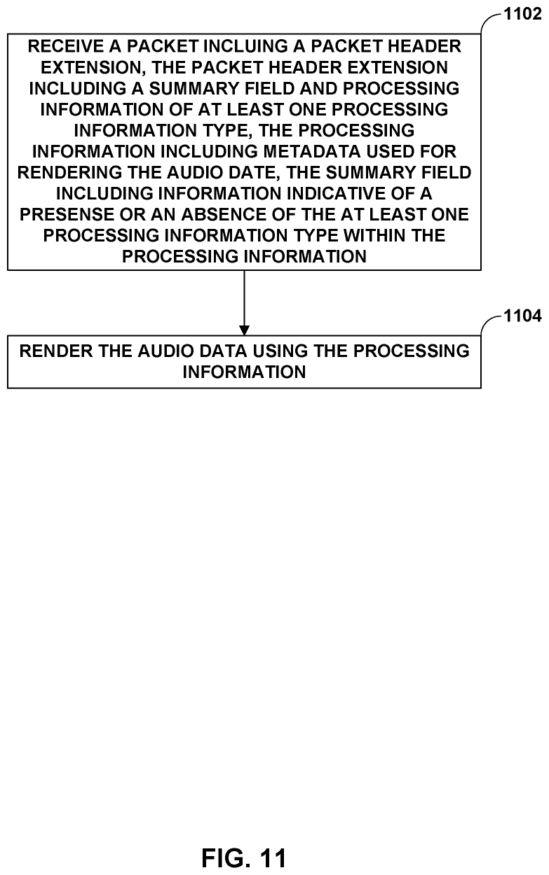

FIG. 11 is a flow diagram illustrating another example use of a hierarchical RTP header extension for processing information according to one or more aspects of this disclosure. While the techniques of FIG. 11 are described with respect to client device 40, these techniques may be practiced by any device capable of doing so.

Client device 40 may receive a packet comprising a packet header extension, the packet header extension including a summary field and processing information of at least one processing information type, the processing information including metadata used for rendering audio data, the summary field including information indicative of a presence or an absence of the at least one processing information type within the processing information (1102). For example, client device 40 may receive the packet from content preparation device 20 or server device 60.

In some examples, the information indicative of the presence or the absence of the at least one processing information type may include a bit map. In some examples, the bit map may include a three-byte bit map, wherein a value of one located at a kth bit of the three-byte bit map indicates a presence of a kth processing information type. In some examples, the summary field may comprise an indicator bit, the indicator bit indicating an existence of an additional structure within the packet header extension, and wherein the additional structure includes a second summary field. In some examples, the packet header extension may include a processing information header section and a processing information frame data section, and wherein the processing information header section includes at least one processing information header. In some examples, the at least one processing information header may include a size field indicating a size of a corresponding processing information frame within the processing information frame data section. In some examples, the at least one processing information header may comprise a flag bit indicating whether a subsequent processing information header follows the at least one processing information header.

Client device 40 may render the audio data using the processing information (1104). For example, client device 40 may use the processing information to assist in rendering the audio data. For example, if the processing information is related to scene orientation, client device 40 may use the processing information in generating or applying the scene orientation.

Various examples of the techniques of this disclosure are summarized in the following clauses:

Clause 1A. A first device comprising one or more processors configured to: generate a packet header extension, the packet header extension comprising a summary field and processing information; and send a packet comprising the packet header extension to a second device.

Clause 2A. The first device of clause 1A, wherein the packet comprises a Real-Time Transport Protocol (RTP) packet.

Clause 3A. The first device of any of clauses 1A-2A, wherein the processing information comprises processing information of one or more types.

Clause 4A. The first device of clause 3A, wherein the one or more types are defined in at least one industry standard.

Clause 5A. The first device of any of clauses 3A-4A, wherein the summary field comprises information indicative of the one or more types of the processing information contained in the packet header extension.

Clause 6A. The first device of any of clauses 3A-5A, wherein the information indicative of the one or more types comprises a bit map wherein a first value of a kth bit of the bit map is indicative of the presence of a kth type of processing information being in the packet header extension.

Clause 7A. The first device of any of clauses 3A-5A, wherein the information indicative of the one or more types comprises a bit map wherein a second value of a kth bit of the bit map is indicative of the absence of a kth type of processing information being in the packet header extension.

Clause 7.1A. The first device of any of clauses 1A-7A, wherein the last bit of the summary field indicates the presence or absence of a second summary field and the associated types.

Clause 8A. The first device of any of clauses 6A-7.1A, wherein the bit map is three bytes in length.

Clause 9A. The first device of any of clauses 1A-8A, wherein the summary section precedes the processing information in the packet header extension.

Clause 10A. The first device of any of clauses 1A-9A, wherein the processing information comprises information for use by the second device or by a renderer for rendering audio information.

Clause 10.1A. The first device of any of clauses 1A-10A, wherein the summary field comprises information indicative of a size of a first processing information frame contained in the packet header extension.

Clause 10.2A. The first device of any of clauses 1A-10.1A, wherein the packet header extension comprises a first packet header extension of a plurality of packet header extensions, and wherein the one or more processors are configured to: generate the plurality of packet header extensions, each of the plurality of packet header extensions comprising a corresponding summary field and corresponding processing information.

Clause 10.3A. The first device of clause 10.2A, wherein each of the plurality of packet header extensions is defined for all possible processing information.

Clause 10.4A. The first device of any of clauses 10.2A-10.3A, wherein each of the plurality of header extensions comprise a same header extension identifier and are not of uniform length.

Clause 10.5A. The first device of any of clauses 10.2A-10.4A, wherein each of the plurality of header extensions comprise a same header extension identifier and at least one of the plurality of header extensions carries a different PI frame and an associated PI header than a remainder of the plurality of header extensions.

Clause 11A. A second device comprising one or more processors configured to: receive a packet comprising a packet header extension from a first device, the packet header extension comprising a summary field and processing information; and render audio information using the processing information.

Clause 12A. The second device of clause 11A, wherein the packet comprises a Real-Time Transport Protocol (RTP) packet.

Clause 13A. The second device of any of clauses 11A-12A, wherein the processing information comprises processing information of one or more types.

Clause 14A. The second device of clause 13A, wherein the one or more types are defined in at least one industry standard.

Clause 15A. The second device of any of clauses 13A-14A, wherein the summary field comprises information indicative of the one or more types of the processing information contained in the packet header extension.

Clause 16A. The second device of any of clauses 13A-15A, wherein the information indicative of the one or more types comprises a bit map wherein a first value of a kth bit of the bit map is indicative of the presence of a kth type of processing information being in the packet header extension.

Clause 17A. The second device of any of clauses 13A-15A, wherein the information indicative of the one or more types comprises a bit map wherein a second value of a kth bit of the bit map is indicative of the absence of a kth type of processing information being in the packet header extension.

Clause 17.1A. The second device of any of clauses 11A-17A, wherein the last bit of the summary field indicates the presence or absence of a second summary field and the associated types.

Clause 18A. The second device of any of clauses 16A-17.1A, wherein the bit map is three bytes in length.

Clause 19A. The second device of any of clauses 11A-18A, wherein the summary section precedes the processing information in the packet header extension.

Clause 19.1A. The second device of any of clauses 11A-19A, wherein the summary field comprises information indicative of a size of a first processing information frame contained in the packet header extension.

Clause 19.2A. The second device of any of clauses 1A-19.1A, wherein the packet header extension comprises a first packet header extension of a plurality of packet header extensions, and wherein the one or more processors are configured to: generate the plurality of packet header extensions, each of the plurality of packet header extensions comprising a corresponding summary field and corresponding processing information.

Clause 19.3A. The second device of clause 19.2A, wherein each of the plurality of packet header extensions is defined for all possible processing information.

Clause 19.4A. The second device of any of clauses 19.2A-19.3A, wherein each of the plurality of header extensions comprise a same header extension identifier and are not of uniform length.

Clause 19.5A. The second device of any of clauses 19.2A-19.4A, wherein each of the plurality of header extensions comprise a same header extension identifier and at least one of the plurality of header extensions carries a different PI frame and an associated PI header than a remainder of the plurality of header extensions.

Clause 20A. A method practiced by the first device of any of clauses 1A-10A or the second device of any of clauses 11A-19.5A.

Clause 21A. Non-transitory computer-readable storage media storing instructions, which when executed by one or more processors, cause the one or more processors to perform the method of clause 20A.

Clause 22A. A device comprising at least one means for performing the method of clause 20A.

Clause 1B. An apparatus for processing audio data, the apparatus comprising one or more memories, and one or more processors in communication with the one or more memories, the one or more processors configured to determine processing information of at least one processing information type, the processing information comprising metadata used for rendering the audio data, generate a packet header extension comprising a summary field and the processing information, the summary field comprising information indicative of a presence or an absence of the at least one processing information type within the processing information, generate a packet comprising the packet header extension, and output the packet.

Clause 2B. The apparatus of Clause 1B, wherein the information indicative of the presence or the absence of the at least one processing information type comprises a bit map.

Clause 3B. The apparatus of Clause 2B, wherein the bit map comprises a three-byte bit map, and wherein a value of one located at a kth bit of the three-byte bit map indicates a presence of a kth processing information type.

Clause 4B. The apparatus of any of Clauses 1B-3B, wherein the summary field comprises an indicator bit, the indicator bit indicating an existence of an additional structure within the packet header extension, and wherein the additional structure comprises a second summary field.

Clause 5B. The apparatus of any of Clauses 1B-4B, wherein the packet header extension comprises a processing information header section and a processing information frame data section, and wherein the processing information header section comprises at least one processing information header.

Clause 6B. The apparatus of Clause 5B, wherein the at least one processing information header comprises a size field indicating a size of a corresponding processing information frame within the processing information frame data section.

Clause 7B. The apparatus of any of Clauses 5B-6B, wherein the at least one processing information header comprises a flag bit indicating whether a subsequent processing information header follows the at least one processing information header.

Clause 8B. The apparatus of any of Clauses 1B-4B, wherein the packet header extension comprises a series of processing information units, and wherein each processing information unit of the series of processing information units comprises a processing information header and a processing information frame.

Clause 9B. The apparatus of any of Clauses 1B-8B, wherein to generate the packet, the one or more processors are further configured to include a plurality of packet header extensions in the packet, the plurality of packet header extensions comprising the packet header extension.

Clause 10B. The apparatus of Clause 9B, wherein each packet header extension of the plurality of packet header extensions comprises a same header extension identifier and are not of uniform length.

Clause 11B. The apparatus of any of Clauses 9B-10B, wherein each of the plurality of packet header extensions comprises a same header extension identifier and at least one of the plurality of packet header extensions carries a different processing information frame and an associated processing information header than a remainder of the plurality of packet header extensions.

Clause 12B. The apparatus of any of Clauses 1B-11B, wherein the packet comprises a Real-Time Transport Protocol (RTP) packet.

Clause 13B. An apparatus for processing audio data, the apparatus comprising one or more memories, and one or more processors in communication with the one or more memories, the one or more processors configured to receive a packet comprising a packet header extension, the packet header extension comprising a summary field and processing information of at least one processing information type, the processing information comprising metadata used for rendering the audio data, the summary field comprising information indicative of a presence or an absence of the at least one processing information type within the processing information, and render the audio data using the processing information.

Clause 14B. The apparatus of Clause 13B, wherein the information indicative of the presence or the absence of the at least one processing information type comprises a bit map.

Clause 15B. The apparatus of Clause 14B, wherein the bit map comprises a three-byte bit map, and wherein a value of one located at a kth bit of the three-byte bit map indicates a presence of a kth processing information type.

Clause 16B. The apparatus of any of Clauses 13B-15B, wherein the summary field comprises an indicator bit, the indicator bit indicating an existence of an additional structure within the packet header extension, and wherein the additional structure comprises a second summary field.

Clause 17B. The apparatus of any of Clauses 13B-16B, wherein the packet header extension comprises a processing information header section and a processing information frame data section, and wherein the processing information header section comprises at least one processing information header.

Clause 18B. The apparatus of Clause 17B, wherein the at least one processing information header comprises a size field indicating a size of a corresponding processing information frame within the processing information frame data section.

Clause 19B. The apparatus of any of Clauses 17B-18B, wherein the at least one processing information header comprises a flag bit indicating whether a subsequent processing information header follows the at least one processing information header.

Clause 20B. A method for processing audio data, the method comprising determining processing information of at least one processing information type, the processing information comprising metadata used for rendering the audio data, generating a packet header extension comprising a summary field and the processing information, the summary field comprising information indicative of a presence or an absence of the at least one processing information type within the processing information, generating a packet comprising the packet header extension, and outputting the packet.

Clause 21B. The apparatus of Clause 1B, wherein the packet header extension includes a four-bit application-specific bits field and a 12-bit identifier that together form a 16-bit profile identifier.

Clause 22B. The apparatus of Clause 13B, wherein the packet header extension includes a four-bit application-specific bits field and a 12-bit identifier that together form a 16-bit profile identifier.

Clause 23B. The apparatus of Clause 13B, wherein the packet header extension includes a series of processing information units, and wherein each processing information unit of the series of processing information units includes a processing information header and a processing information frame.

Clause 24B. The apparatus of Clause 8B, wherein the processing information header includes a one-bit reserved field, a two-bit frame marker field indicating an associated audio frame for the processing information frame, a five-bit type field, and an eight-bit size field.

Clause 25B. The apparatus of Clause 23B, wherein the processing information header includes a one-bit reserved field, a two-bit frame marker field indicating an associated audio frame for the processing information frame, a five-bit type field, and an eight-bit size field.

In one or more examples, the functions described may be implemented in hardware, software, firmware, or any combination thereof. If implemented in software, the functions may be stored on or transmitted over as one or more instructions or code on one or more computer-readable media and executed by one or more hardware-based processing units. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include one or more computer-readable media.

By way of example, and not limitation, such computer-readable storage media can comprise RAM, ROM, EEPROM, CD-ROM and/or other optical disk storage, magnetic disk storage, and/or other magnetic storage devices, flash memory, and/or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus for processing audio data, the apparatus comprising:
one or more memories; and
one or more processors in communication with the one or more memories, the one or more processors configured to:
determine processing information of at least one processing information type, the processing information comprising metadata used for rendering the audio data;
generate a packet header extension comprising a summary field and the processing information, the summary field comprising information indicative of a presence or an absence of the at least one processing information type within the processing information;
generate a packet comprising the packet header extension; and
output the packet.

2. The apparatus of claim 1, wherein the information indicative of the presence or the absence of the at least one processing information type comprises a bit map.

3. The apparatus of claim 2, wherein the bit map comprises a three-byte bit map; and
wherein a value of one located at a kth bit of the three-byte bit map indicates a presence of a kth processing information type.

4. The apparatus of claim 1, wherein the summary field comprises an indicator bit, the indicator bit indicating an existence of an additional structure within the packet header extension; and
wherein the additional structure comprises a second summary field.

5. The apparatus of claim 1, wherein the packet header extension comprises a processing information header section and a processing information frame data section; and
wherein the processing information header section comprises at least one processing information header.

6. The apparatus of claim 5, wherein the at least one processing information header comprises a size field indicating a size of a corresponding processing information frame within the processing information frame data section.

7. The apparatus of claim 5, wherein the at least one processing information header comprises a flag bit indicating whether a subsequent processing information header follows the at least one processing information header.

8. The apparatus of claim 1, wherein the packet header extension comprises a series of processing information units; and
wherein each processing information unit of the series of processing information units comprises a processing information header and a processing information frame.

9. The apparatus of claim 1, wherein to generate the packet, the one or more processors are further configured to:
include a plurality of packet header extensions in the packet, the plurality of packet header extensions comprising the packet header extension.

10. The apparatus of claim 9, wherein each packet header extension of the plurality of packet header extensions comprises a same header extension identifier and are not of uniform length.

11. The apparatus of claim 9, wherein each of the plurality of packet header extensions comprises a same header extension identifier and at least one of the plurality of packet header extensions carries a different processing information frame and an associated processing information header than a remainder of the plurality of packet header extensions.

12. The apparatus of claim 1, wherein the packet comprises a Real-Time Transport Protocol (RTP) packet.

13. An apparatus for processing audio data, the apparatus comprising:
one or more memories; and
one or more processors in communication with the one or more memories, the one or more processors configured to:
receive a packet comprising a packet header extension, the packet header extension comprising a summary field and processing information of at least one processing information type, the processing information comprising metadata used for rendering the audio data, the summary field comprising information indicative of a presence or an absence of the at least one processing information type within the processing information; and
render the audio data using the processing information.

14. The apparatus of claim 13, wherein the information indicative of the presence or the absence of the at least one processing information type comprises a bit map.

15. The apparatus of claim 14, wherein the bit map comprises a three-byte bit map;
and wherein a value of one located at a kth bit of the three-byte bit map indicates a presence of a kth processing information type.

16. The apparatus of claim 13, wherein the summary field comprises an indicator bit, the indicator bit indicating an existence of an additional structure within the packet header extension;
and wherein the additional structure comprises a second summary field.

17. The apparatus of claim 13, wherein the packet header extension comprises a processing information header section and a processing information frame data section;
and wherein the processing information header section comprises at least one processing information header.

18. The apparatus of claim 17, wherein the at least one processing information header comprises a size field indicating a size of a corresponding processing information frame within the processing information frame data section.

19. The apparatus of claim 17, wherein the at least one processing information header comprises a flag bit indicating whether a subsequent processing information header follows the at least one processing information header.

20. A method for processing audio data, the method comprising:
determining processing information of at least one processing information type, the processing information comprising metadata used for rendering the audio data;
generating a packet header extension comprising a summary field and the processing information, the summary field comprising information indicative of a presence or an absence of the at least one processing information type within the processing information;
generating a packet comprising the packet header extension; and
outputting the packet.
